(19) United States
(12) Patent Application Publication
(10) Pub. No.: US 2002/0075387 A1
(43) Pub. Date: Jun. 20, 2002

(54) Arrangement and process for monitoring the surrounding area of an automobile

(76) Inventor: Holger Janssen, Hessisch Oldendorf (DE)

Correspondence Address: STRIKER, STRIKER & STENBY, 103 East Neck Road, Huntington, NY, 11743, US

(21) Appl. No.: 09/999,571

(22) Filed: Nov. 15, 2001

(30) Foreign Application Priority Data
Nov. 29, 2000 (DE) 100 59 315.1

(51) Int. Cl. H04N 7/18; H04N 9/47

(52) U.S. Cl. 348/148

(57) ABSTRACT

The invention relates to an arrangement for monitoring the surrounding area of a motor vehicle (10) including a wide-angle camera (12), a picture-processing unit (14) with means for correcting distortion in a picture produced by the camera (12), and a picture display unit (16). The means for correcting distortion in the picture adaptively operates based on a selected picture detail (18) and a selected line of vision (20). The invention further relates to a method for monitoring the surrounding area of a motor vehicle.

### BACKGROUND OF THE INVENTION

The present invention relates generally to systems for monitoring the surrounding area of a motor vehicle.

More particularly, the present invention relates to an arrangement for monitoring the surrounding area of a motor vehicle including at least one wide-angle-lens camera, a picture processing unit having means for eliminating distortion of the photograph produced from the camera, and a picture display unit. The invention further comprises a process for monitoring the surrounding area of a motor vehicle including the steps of determining a wide-angle area with a camera, eliminating distortion from a photo or picture produced by the camera with a photo-processing unit, and displaying at least one picture with a picture display unit.

Numerous systems are known for monitoring the surroundings of a motor vehicle. Systems of this type are typically used for realization of a “precrash” scenario (i.e., for preventing accidents), for automatic cruise control (ACC), and for observation of blind angles with reference to the field of vision of the driver. These systems usually utilize various sensors. For example, radar sensors, lidar sensors, ultrasonic sensors, and video sensors have been used in such monitoring systems.

The rear area of the vehicle represents a very difficult area to monitor. However, monitoring of this rear area is both logical and desirable when parking or otherwise maneuvering the vehicle when the rear area behind the car is difficult to see.

Many positioning elements for use in many different applications have been developed for video-monitoring systems for observing the area behind a vehicle. In one such application, such as the use of video systems as a rearview mirror substitute, or as a supplemental to a rear-view mirror, or as parking assistance, the driver is shown camera pictures that allow the driver to see and monitor areas that are not directly visible and to view blind angles.

It is known in the prior art to directly display the pictures taken by the video camera or to make minimal adjustments to the picture contents. Adjustments or changes or this type, for example, are made to the brightness and the contrast of the picture contents.

Based on the direct display of the picture contents, the photograph optics should only have minimal optical distortion. However, it must be ensured that the user, that is, the vehicle's driver, can interpret the picture contents without any problem. This limits the area of the useable optics to lenses with low distortion. Therefore, only lens can be used which have a comparatively small viewing angle.

If one wishes to monitor larger portions of the area surrounding the vehicle with a system based on a video camera, it is therefore necessary to install several cameras, each of which monitors a different portion of the area surrounding the vehicle. Thus, the driver is shown several pictures produced from these several cameras. This has the disadvantage of imposing additional requirements on the driver, since the driver must then arrange the various images produced by the several cameras with additional and well thought-out efficiency. Another possibility for using the information from several cameras consists of combining the information into a total and complete picture. This type of system, however, is complex and unmonitorable. Further, frequently optical damage occurs in the areas in which the various images cross or merge into one another.

Likewise, it has been proposed in the prior art to use a single, pivotable camera, rather than several cameras. This solution, however, has the associated disadvantage that an expensive mechanism is required for positioning the camera.

### SUMMARY OF THE INVENTION

The present invention addresses and resolves the above disadvantages by providing an arrangement in which the means for correcting distortions adaptively works on the basis of a selected picture detail and in which the means for correcting distortion adaptively operates on the basis of a selected line of vision. Through the wide-angle camera of the present invention, a larger portion of the area surrounding the vehicle can be monitored with only one camera. The distortion resulting from the use of the wide-angle lens is then inventively corrected, whereby this distortion correction adaptively operates on the basis of a selected picture detail. In addition, the means for correcting distortions adaptively works on the basis of a selected line of vision. Thus, highly selective information can be delivered to the driver, which to the driver is the most informative, based on the distortion correction and an intuitive, true-to-life representation of the surrounding area.

In the frame of the present invention, the distortion correction can be an arbitrary, two-dimensional image of the camera image plane in the image plane of the display picture. The image specifications can have arbitrary mathematical complexity. Essentially, the distortion correction projects the distorted picture onto an image plane. Based on the variability of the mathematical image possibilities, the image distortion of the picture contents also contains a reflection of the picture or other, arbitrary geometric operators. With the tuning or adjustment based on a selected line of vision, a panorama view or a bird's-eye view can be realized. The panorama view is suited particularly for gross maneuvering of the vehicle, since this view basically corresponds to the backward view from the rear window. The bird's-eye view can be used for centimeter-accurate parking, since, in this manner, distances to obstacles can be observed particularly well by the driver. Also, other arbitrary lines of vision in the photographic area of the sensor are contemplated.

Preferably, the fitting or tuning of a selected picture detail and/or a selected line of vision takes place through the driver. The driver, then, can also actively affect the means for correcting distortion.

However, it can also be advantageous that the adjustment of a selected picture detail and/or a selected line of vision is performed automatically. For this automatic adjustment of the selected picture detail and/or the chosen line of vision, much information can be utilized, whereby this information advantageously is tied into the algorithm.

In the arrangement of the present invention, it is also possible that the adjustment of a selected picture detail and/or a chosen line of vision occurs automatically based on the picture contents. For example, upon the sudden appearance of an object in the area detected by the camera, the line of vision that is represented for the driver is guided in the direction of this object. In addition, it is possible to so select the picture detail that the object and relevant information in the area surrounding this object is represented.

It can be advantageous if the adjustment of a selected picture detail and/or a selected line of vision automatically is initiated when the vehicle is put into reverse. This initiation can take place parallel to the activation of the display device, whereby the initiation includes a distortion correction with standard operation.

Particularly advantageous for the present invention is if the adjustment of a selected picture detail and/or a selected line of vision automatically takes place on the basis of the steering angle of the vehicle. Since the direction in which the vehicle travels is determined from the steering angle, this also has an effect on the area that particularly interests the driver. In this regard, the adjustment of the display parameters on the basis of the steering angle is especially useful.

It can also be advantageous if the adjustment of a selected picture detail and/or a selected line of vision takes place automatically based on the speed of the vehicle. If the vehicle is traveling slowly, typically the driver wishes to make fine, or more precise, maneuvers. In this case, a precise observation of a small picture area is logical, which is largely directed toward the bumper of the vehicle. However, if the vehicle is traveling more quickly, the driver typically wants to perform larger, gross movements to bring the vehicle into the desired position. Therefore, the display and the distortion correction provide a larger picture area. In this case, the panorama perspective is largely preferred as the line of vision.

It is also advantageous that the adjustment of the selected picture detail and/or the selected line of vision takes place automatically based on the angle of pitch of the camera with reference to the surface on which the vehicle is traveling, that is, a road or street. The angle of pitch of the camera is affected by the angle of pitch of the vehicle with reference to the road. Thus, it is logical to take into account the picture orientation upon selection of the respective picture detail.

In a preferred embodiment of the arrangement of the present invention, the camera is a high dynamic range camera, or an HDRC-camera. This type of camera has a large brightness dynamic so that it can improve the picture quality, particularly in critical illumination situations (darkness, counterlight or glare, or snow, for example).

Likewise, it can be advantageous if an actuating system can be affected through input of the picture-processing unit. Such an actor device can directly engage or control the operating behavior of the vehicle, for example, braking operations.

The present invention also concerns a method in which the distortion correction is adaptively performed on the basis of a selected picture detail and in which the distortion correction adaptively takes place based on a selected line of vision. Through a wide-angle camera, a larger portion of the surrounding area of the vehicle can be observed with only one camera. The distortion that results from the wide-angle lens can be corrected now according to the method of the present invention, whereby this distortion correction adaptively operates based on a selected picture detail. In addition, the means for correcting distortion adaptively works based on a selected line of vision. Thus, highly selective information can be delivered to the driver, which to the driver is the most informative, based on the distortion correction and an intuitive, true-to-life representation of the surrounding area.

In the frame of the method of the present invention, the distortion correction can be an arbitrary, two-dimensional image of the camera image plane in the image plane of the display picture. The image specifications can have arbitrary mathematical complexity. Essentially, the distortion correction projects the distorted picture onto an image plane. Based on the variability of the mathematical image possibilities, the image distortion of the picture contents also contains a reflection of the picture or other, arbitrary geometric operators. With the tuning or adjustment on the basis of a selected line of vision, a panorama view or a bird's-eye view can be realized. The panorama view is suited particularly for gross maneuvering of the vehicle, since this view basically corresponds to the backward view from the rear window. The bird's-eye view can be used for centimeter-accurate parking, since, in this manner, distances to obstacles can be observed particularly well by the driver. Also, other arbitrary lines of vision in the photographic area of the sensor are contemplated.

Preferably, the tuning of a selected picture detail and/or a selected line of vision is performed the driver in the inventive method. The driver, then, can also actively affect the means for correcting distortion.

However, it can also be advantageous that the adjustment of a selected picture detail and/or a selected line of vision is performed automatically. For this automatic adjustment of the selected picture detail and/or the chosen line of vision, much information can be utilized, whereby this information advantageously is tied into the algorithm.

It is also particularly preferred in the method of the present invention that the adjustment of a selected picture detail and/or a chosen line of vision occurs automatically based on the picture contents. For example, upon sudden appearance of an object in the area detected by the camera, the line of vision that is represented for the driver is guided in the direction of this object. In addition, it is possible to so select the picture detail that the object and relevant information in the area surrounding this object is represented.

In the inventive method, it can be advantageous if the adjustment of a selected picture detail and/or a selected line of vision automatically is initiated when the vehicle is put into reverse. This initiation can take place parallel to the activation of the display device, whereby the initiation includes a distortion correction with standard operation.

Particularly advantageous for the method of the present invention is if the adjustment of a selected picture detail and/or a selected line of vision automatically takes place based on the steering angle of the vehicle. Since the direction in which the vehicle travels is determined from the steering angle, this also has an effect on the area that particularly interests the driver. In this regard, the adjustment of the display parameters on the basis of the steering angle is especially useful.

With the method of the present invention, it can also be advantageous if the adjustment of a selected picture detail and/or a selected line of vision takes place automatically based on the speed of the vehicle. If the vehicle is traveling slowly, typically the driver wishes to make fine, or more precise, maneuvers. In this case, a precise observation of a small picture area makes sense, which is largely directed toward the bumper of the vehicle. However, if the vehicle is traveling more quickly, the driver typically wants to perform larger, gross movements to bring the vehicle into the desired position. Therefore, the display and the distortion correction provide a larger picture area. In this case, the panorama perspective is largely preferred as the line of vision.

Advantageously, the adjustment of the selected picture detail and/or the selected line of vision takes place in the inventive method automatically, based on the angle of pitch of the camera with reference to the surface on which the vehicle is traveling, that is, a road or street. The angle of pitch of the camera is affected by the angle of pitch of the vehicle with reference to the road. Thus, it is logical to take into account the picture orientation upon selection of the respective picture detail.

It is preferred that the camera used in the method of the present invention is a high dynamic range camera, or an HDRC-camera. This type of camera has a large brightness dynamic so that it can improve the picture quality, particularly in critical illumination situations (darkness, counterlight or glare, or snow, for example).

Likewise, it can be advantageous to the inventive method if an actuating system can be affected through input of the picture-processing unit. Such an actor device can directly engage or control the operating behavior of the vehicle, for example, braking or steering operations.

The underlying basis of the present invention is the surprising knowledge that through the adaptive distortion correction, based on a selected picture detail and a selected line of vision, particularly relevant information can be transmitted to the driver. The driver can determine the selection or the adjustment of this information, in one embodiment. In another embodiment, it is also possible to automatically affect or to completely and automatically control the adjustment or selection of this information. Compared to systems in which several cameras are used, in order to observe a large angle of vision, the inventive arrangement shows that this same result can be achieved by use of only a single camera, whereby the manufacturing expenditures are minimized and problems relating to transition areas between pictures of the various cameras are eliminated.

The novel features which are considered as characteristic of the present invention are set forth in particular in the appended claims. The invention itself, however, both as to its construction and its method of operation, together with additional objects and advantages thereof, will be best understood from the following description of the specific embodiments when read in connection with the accompanying drawings.

### BRIEF DESCRIPTION OF THE DRAWINGS

FIG. 1 shows a schematic representation of the arrangement of the present invention;

FIG. 2 is a schematic plan view of a vehicle utilizing the arrangement of the present invention;

FIG. 3 is a lateral, partial view of a vehicle utilizing the arrangement of the present invention; and

FIG. 4 is a schematic block diagram showing the operation of the arrangement of the present invention.

### DETAILED DESCRIPTION OF THE PREFERRED EMBODIMENTS

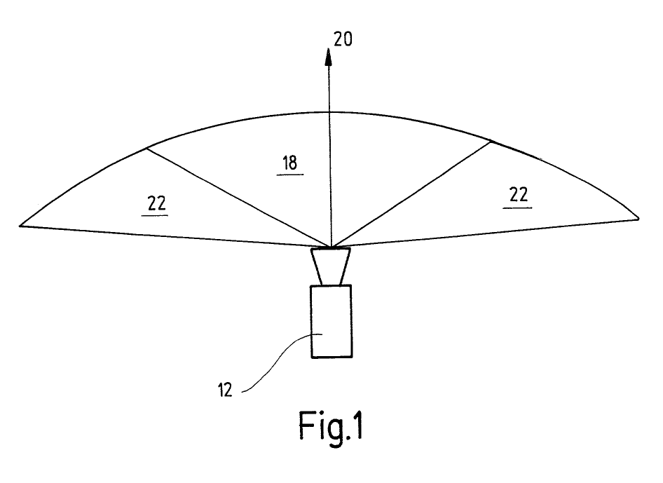

FIG. 1 shows a camera 12, which, by means of a wide-angle optic, picks up a nearby semi-circular shaped angle of vision 22. If one were to bring the picture detected by the camera 12 to a display device, the picture would be distorted. This would result in difficulty understanding the contents of the picture. According to the present invention, then, a smaller picture detail 18 is selected. This detail 18 is represented in FIG. 1, by way of example, in the line of vision 20, which is the straight (or non-angled) direction of the camera 12. The choice of the line of vision 20 as well as the picture detail 18 can be adjusted, whereby this adjustment is affected by an operator, such as the driver, and/or automatically takes place.

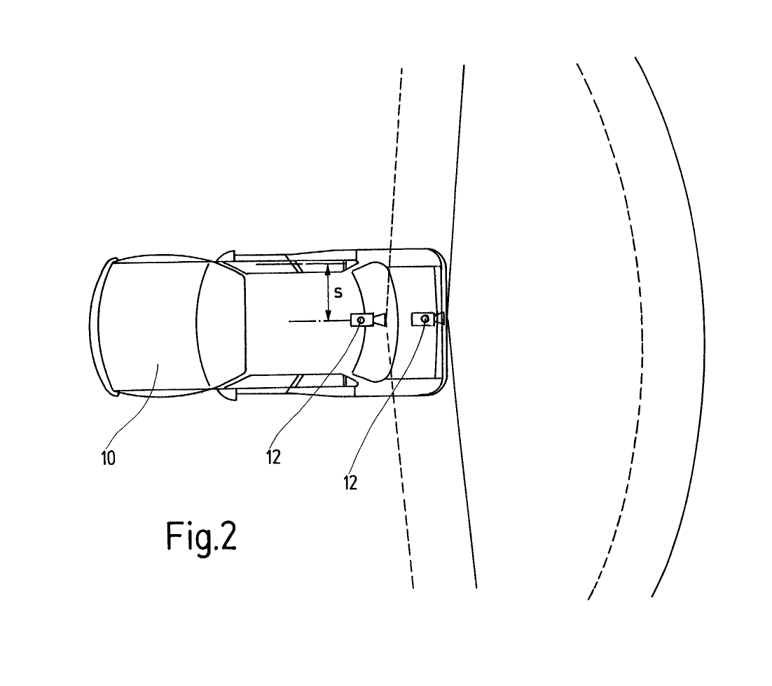

In FIG. 2, a top view of a vehicle is represented, which shows possible positioning choices for the camera 12. The position of the camera is described through the parameter S. FIG. 2 shows several cameras 12 for the purposes of illustrating where the camera can be positioned in the arrangement.

The camera 12, shown in FIG. 2, serves for observing the reverse movement of the vehicle. Two illustrative areas that can be monitored by the camera 12 are shown in FIG. 2.

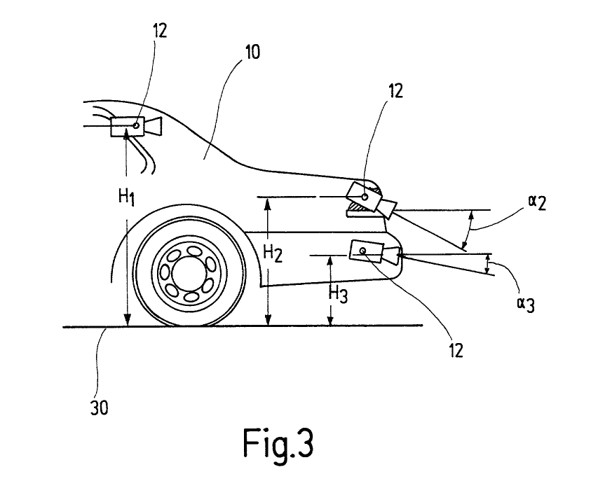

FIG. 3 is a lateral, partial view of a vehicle 10. Also in FIG. 3, by way of example, the positioning of the camera 12 is shown. The cameras 12 are arranged at heights H₁, H₂, and H₃. The camera which is positioned at the height H₁ has an angle of gradient of 0° with reference to the traveling surface or road 30. In this manner, a panorama perspective is made possible. The camera 12 positioned at the height H₂ has an angle of gradient α₂ compared with the road 30. With this camera positioning, a bird's-eye view provides a particularly good view of maneuvers that require more accuracy. A further possible position for the camera 12 is at the height H₃ at an angle α₃ relative to the road 30. All of the perspectives, however, can be calculated from all of the possible camera arrangements. The camera having the height H₁ can also supply a projection of the bird's-eye view, in which the distortion correction of the camera picture calculates the bird's-eye view from the camera picture. The camera position, in view of the height and direction, is not decisive for the line of vision of the corrected picture. The line of vision is determined per a distortion correction algorithm. However, the direction must be contained in the picture of the camera.

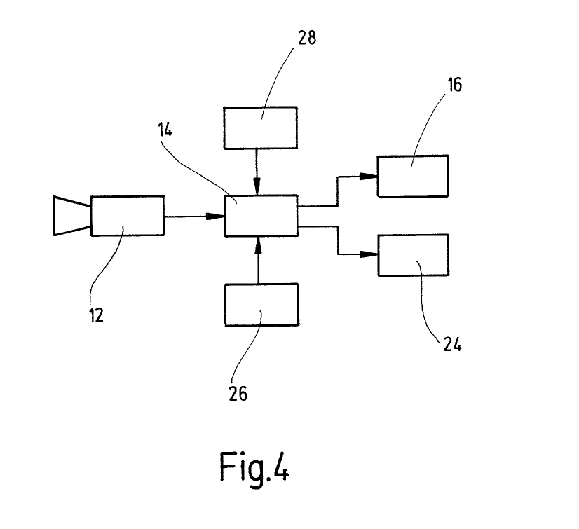

FIG. 4 shows a schematic block diagram for further clarification of the inventive arrangement. A camera 12 provides information to a picture-processing unit 14. Furthermore, this picture-processing unit 14 is supplied with camera parameters from a unit 26 and with vehicle parameters from a unit 28. The picture-processing unit 14 produces picture display information through the use of an appropriate mathematical algorithm for a picture display unit 16, which, in the inventive manner, corrects distortion. Further, it can be provided that the picture-processing unit supplies input to an actor 24, which directly engages or controls the vehicle's behavior, such as, by way of example, the steering or the braking actions. As information is supplied from the vehicle parameter unit 28, information about the supplied operation, such as the steering angle of the vehicle, the speed of the vehicle, and the tilt angle of the vehicle with reference to the road, is made possible.

It will be understood that each of the elements described above, or two or more together, may also find a useful application in other types of constructions differing from the types described above.

While the invention has been illustrated and described herein as an arrangement and method for monitoring the surrounding area of a motor vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An arrangement for monitoring the surrounding area of a motor vehicle (10), comprising:
at least one wide-angle camera (12);
a picture processing unit (14) having means for correcting distortion in a picture produced by said camera (12), wherein said means for correcting distortion adaptively operates based on a selected picture detail (18) and based on a selected line of vision (20); and
a picture display unit (16).

2. The arrangement as defined in claim 1, wherein an adjustment of said selected picture detail (18) and/or said selected line of vision (20) is performed by a driver of said motor vehicle.

3. The arrangement as defined in claim 1, wherein an adjustment of said selected picture detail (18) and/or said selected line of vision (20) is performed automatically.

4. The arrangement as defined in claim 1, wherein an adjustment of said selected picture detail (18) and/or said selected line of vision (20) is automatically performed based on the contents of said picture.

5. The arrangement as defined in claim 1, wherein an adjustment of said selected picture detail (18) and/or said selected line of vision (20) is automatically initiated when said motor vehicle is placed into reverse gear.

6. The arrangement as defined claim 1, wherein an adjustment of said selected picture detail (18) and/or said selected line of vision (20) automatically takes place based on the steering angle of the motor vehicle.

7. The arrangement as defined in claim 1, wherein an adjustment of said selected picture detail (18) and/or said selected line of vision (20) automatically takes place based on a speed of the motor vehicle.

8. The arrangement as defined in claim 1, wherein an adjustment of said selected picture detail (18) and/or said selected line of vision (20) automatically takes place based on the angle of gradient of said camera (12) with reference to a roadway (30) traveled by said motor vehicle.

9. The arrangement as defined in claim 1, wherein the camera (12) is a high dynamic range camera.

10. The arrangement as defined in claim 1, wherein an actor device (24) of said motor vehicle is affected by input of said picture-processing unit (14).

11. A method for monitoring the surrounding area of a motor vehicle, said methods comprising the steps of:
determining an angle region (22) with a camera;
correcting distortion in a picture produced by said camera picture-processing unit (14), wherein said distortion correction takes place based on a selected picture detail and wherein said distortion correction takes place based on a selected line of vision; and
displaying at least one picture on a picture display unit (16).

12. The method as defined in claim 11, wherein an adjustment of said selected picture detail (18) and/or said selected line of vision (20) is performed by a driver of said motor vehicle.

13. The method as defined in claim 11, wherein an adjustment of said selected picture detail (18) and/or said selected line of vision (20) is performed automatically.

14. The method as defined in claim 11, wherein an adjustment of said selected picture detail (18) and/or said selected line of vision (20) is automatically performed based on the contents of said picture.

15. The method as defined in claim 11, wherein an adjustment of said selected picture detail (18) and/or said selected line of vision (20) is automatically initiated when said motor vehicle is placed into reverse gear.

16. The method as defined claim 11, wherein an adjustment of said selected picture detail (18) and/or said selected line of vision (20) automatically takes place based on the steering angle of the motor vehicle.

17. The method as defined in claim 11, wherein an adjustment of said selected picture detail (18) and/or said selected line of vision (20) automatically takes place based on a speed of the motor vehicle.

18. The method as defined in claim 11, wherein an adjustment of said selected picture detail (18) and/or said selected line of vision (20) automatically takes place based on the angle of gradient of said camera (12) with reference to a roadway (30) traveled by said motor vehicle.

19. The method as defined in claim 11, wherein the camera (12) is a high dynamic range camera.

20. The method as defined in claim 11, wherein an actor device (24) of said motor vehicle is affected by input of said picture-processing unit (14).
